(19) United States
(12) Patent Application Publication
(10) Pub. No.: US 2012/0239680 A1
(43) Pub. Date: Sep. 20, 2012

(54) GENERATING DATABASE SCRIPTS FOR EXECUTING BUSINESS RULES RELATED TO ENTERPRISE SOFTWARE IN A DATABASE RUNTIME ENVIRONMENT

(76) Inventors: RAHUL GUDLA, Hyderabad (IN); Abhinaw Sachan, Kanpur (IN)

(21) Appl. No.: 13/050,967

(22) Filed: Mar. 18, 2011

(51) Int. Cl. G06F 7/00; G06F 17/30

(52) U.S. Cl. 707/769; 707/803; 707/E17.014; 707/E17.044

(57) ABSTRACT

Various embodiments of systems and methods for generating database scripts for executing business rules in a database runtime environment are described herein. A method includes retrieving one or more business rules from a rule repository, identifying a format of the business rule, based upon the identified format, selecting a script generator code for generating one or more database scripts for the business rule, and sending the generated database scripts to a database for execution in the database runtime environment. The execution of generated database scripts in the database runtime environment ensures a faster and efficient execution of business rules. Further, the business rules can be retrieved from a business rule management system (BRMS) where the rules can be easily composed by business users. Importantly, the method enables an efficient generation of the business rules using BRMS along with efficient execution of the generated business rules in the database runtime environment.

### FIELD

The technical field relates generally to business rules, and more particularly to executing business rules related to enterprise software in a database runtime environment.

### BACKGROUND

A business rule is a logical construct that describes operations, definitions, conditions, and/or constraints. The business rule is composed (written) to achieve or realize one or more results. Essentially, the business rule is executed (implemented) on a software data object. As a result of execution, the one or more results specified in the business rule is achieved/realized. For example, in an enterprise software system having an employee vacation request module, a business rule may be composed to automatically grant leave to an employee if a leave is applied for less than 2 days. The business rule for the above mentioned case may be composed as:

“if <leave duration> applied by an <employee> is less than 2 days, then grant leave to the <employee> without asking a manager of the <employee>”

Essentially, the above stated business rule determines the leave duration for the employee (data object) and if the leave duration is less than 2 days, the leave is automatically granted (result achieved).

Usually, the business rule(s) are encoded directly in the enterprise software (business) application. A software developer encodes (maintains) the business rules in the software application. Essentially, a business user (e.g., a policies owner, a business analyst, etc) discusses/explains the business rule(s) to the software developer and the software developer encodes the business rule(s) based upon the requirement of the business user. However, it may be inconvenient for the business user to rely on the software developer for composing and/or updating the business rule(s). Further, the business rule(s) may change frequently, e.g., due to regulatory changes, competitor moves, etc., and the business user may need to frequently depend on the software developer for updating the existing rules. Additionally, the rules encoded or updated by the software developer need to be tested and go through usual IT delivery cycle which may be time consuming.

A business rule management system (BRMS) is developed to enable business users to compose and maintain the business rules themselves. The rules composed by the business users may then be stored and processed by the BRMS. In the BRMS, the business users may take charge of the business rules maintenance. For instance, a telephone service provider can launch a new calling plan by simply composing a new rule set, in the BRMS. Essentially, the BRMS externalizes the business rules from the software application code and also saves time by shortening the usual IT delivery cycle.

Usually, the BRMS is accessed through the software application that is meant for using the business rule(s). Basically, the software application loads the data from a database, creates a platform specific (e.g., JAVA®, .NET®, etc) instances (of data objects) based on the data, passes the data object to the BRMS for appropriate rule(s) to be applied, receives a modified data object from the BRMS, and stores the modified data object in the database.

However, when the rule(s) need to be applied to a large volume of data, the software application fails to deliver the required performance. The performance drag may be because of loading of data from the database, converting the data to the platform specific data object, passing the data object to the BRMS, receiving the modified data object from the BRMS, and storing the modified data object back in the database. Essentially, the movement of the large volume of data to/from the database and computation done by the software application drags the performance down. Further, the rule(s) may need to be executed on historical data (e.g., the data of last 3 years) to determine a current business event/transaction. The software application is written to load the data based upon the rules encoded in the software application (i.e., the data of last 3 years). However, if the rule(s) gets edited/updated in the BRMS (e.g., the updated rule requires to be executed on the data of last 5 years) then it would be required to update the rule(s) in the software application as well to load a correct data (i.e., the data of last 5 years). Again, it might be inconvenient to inform the software developer each time the business rule(s) get updated. Additionally, updating the rules in the software application might be cumbersome.

It would be desirable, therefore, to provide a system and method for efficiently executing the business rules that obviates the above mentioned problems.

### SUMMARY

Various embodiments of systems and methods for generating database scripts for executing one or more business rules, related to enterprise software, in a database runtime environment are described herein. In one aspect, the one or more business rules are retrieved from a rule repository, a format in which the business rule is expressed is identified, and based upon the identified format, a script generator code from a plurality of script generator codes is selected to generate one or more database scripts corresponding to the business rule. The selected script generator code is executed to generate the one or more database scripts, and the generated database scripts are sent to a database for execution in the database runtime environment. The execution of the generated database script(s) in the database runtime environment ensures a faster and efficient execution of the corresponding business rule. Further, the business rules may be retrieved from a business rule management system (BRMS) where the business rules can be easily composed by a business user. Therefore, the business rules can be efficiently generated using the BRMS as well as efficiently executed in the database runtime environment.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system including a converter for generating database scripts for executing business rules inside a database, according to an embodiment of the invention.

FIG. 2 is a block diagram of a rule generation engine coupled to a rule repository for generating and storing the business rules, according to an embodiment of the invention.

FIG. 3 is a block diagram of a business rule management system (BRMS) for generating and storing business rules, according to an embodiment of the invention.

FIG. 4 is a block diagram of the converter coupled to an external source for retrieving business rules from the rule repository, according to an embodiment of the invention.

FIG. 5 is a flow chart illustrating the steps performed to generate database scripts for executing business rules in a database runtime environment, according to various embodiments of the invention.

FIG. 6 is a flow chart illustrating the steps performed to generate database scripts for updated business rule(s), according to an embodiment of the invention.

FIG. 7 is a flow chart illustrating the steps performed to execute business rules in the database runtime environment, according to an embodiment of the invention.

FIG. 8 is a block diagram of an exemplary computer system, according to an embodiment of the invention.

### DETAILED DESCRIPTION

Embodiments of techniques for generating database scripts for executing business rules related to enterprise software in a database runtime environment are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

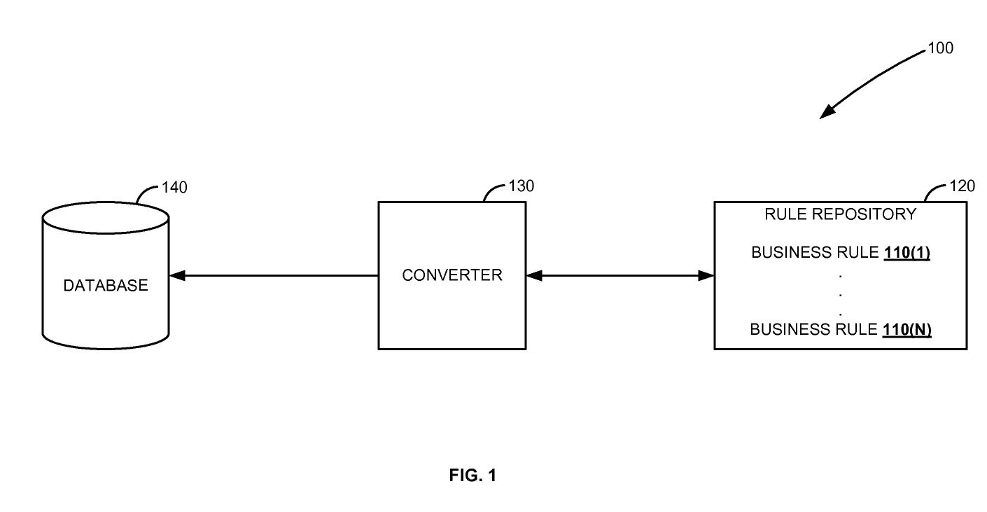

FIG. 1 illustrates one embodiment of a system 100 for generating database scripts (not shown) for executing one or more business rules 110 (1-N) inside a database 140. Essentially, the business rules 110 (1-N) are stored in a rule repository 120. Each of the stored business rules 110 (1-N) are expressed in one of a plurality of formats (not shown). A converter 130 retrieves the business rules 110 (1-N) from the rule repository 120. The converter 130 identifies the format of each of the business rules 110 (1-N) and based upon their identified format, generates one or more database scripts corresponding to each business rule. The generated database scripts are sent to the database 140 for execution. The database 140 executes the database scripts in a database runtime environment. Importantly, the business rules 110 (1-N) are executed as database scripts inside the database 140.

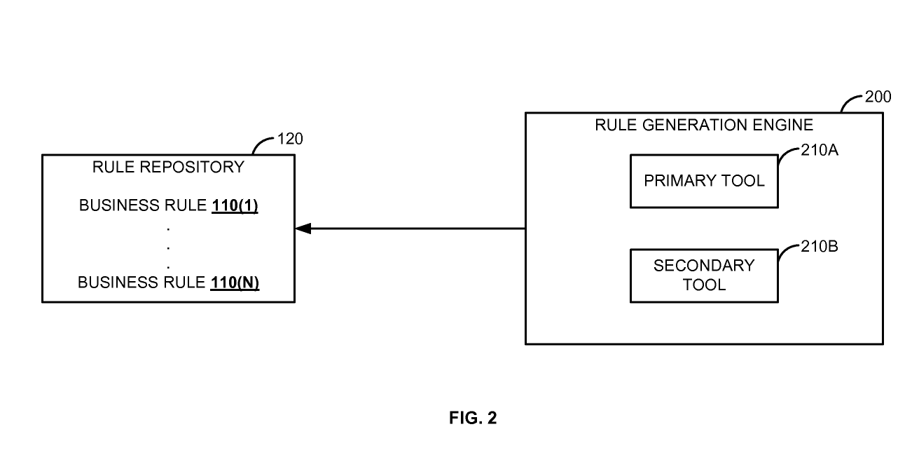

The business rules 110 (1-N) are generated by a rule generation engine 200 (refer to FIG. 2). The rule generation engine 200 may include a primary tool 210A to enable a business user (e.g., a policy owner, business analyst, etc) to generate a new business rule and/or to update the existing business rules 110 (1-N). Further, the rule generation engine 200 may also include a secondary tool 210B to enable a software developer to generate and/or maintain the business rules 110 (1-N).

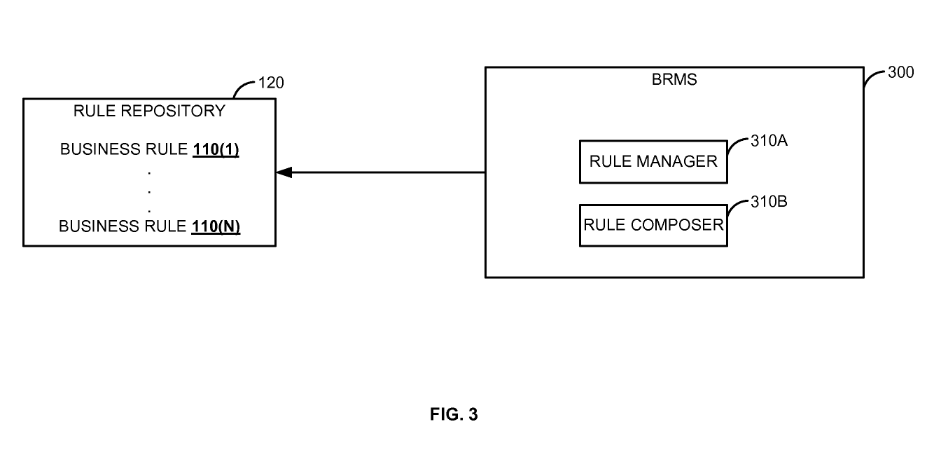

In one embodiment, the rule generation engine 200 may be a business rule management system (BRMS) 300 (refer to FIG. 3). Essentially, the BRMS 300 comprises a rule manager 310A to enable the business user to generate and/or update the business rules 110 (1-N) and a rule composer 310B to enable the software developer to generate new business rule(s), define the business rules 110 (1-N), establish relationship between one or more business rules 110 (1-N), and/or generate a processing logic to bind the business rules 110 (1-N) to one or more data.

The business rules 110 (1-N) generated by the rule generation engine 200 may be in one of the plurality of formats. The format may be one of a decision table, a decision tree, a conditional statement, an iterative loop statement, a branch condition, and/or any other suitable graphical or a non-graphical representation. Essentially, the format of each business rules 110 (1-N) is determined by the business users and/or the software developer who generates the business rules 110 (1-N). The generated business rules 110 (1-N) are stored in the rule repository 120.

The rule repository 120 may be a file repository and/or a database repository. In one embodiment, the rule repository 120 may be a component of the BRMS 300. In another embodiment, the rule repository 120 may be positioned outside the BRMS 300. The business rules 110 (1-N) may be retrieved from the rule repository 120. Essentially, the converter 130 retrieves the business rules 110 (1-N) from the rule repository 120. In one embodiment, the converter 130 may be installed on a central computer or a server (not shown). In another embodiment, the converter 130 may be a component of the rule generation engine 200.

The converter 130 may monitor the rule repository 120 to investigate a new and/or updated business rule(s). In one embodiment, the converter 130 may monitor the rule repository 120 at a predefined time interval. In another embodiment, the converter 130 may monitor the rule repository 120 continuously on a real time basis to investigate the new and/or updated business rule(s). If the new business rule(s) are stored in the rule repository 120 or the one or more existing business rules 110 (1-N) are updated, the converter 130 retrieves the new and/or updated business rule(s) from the rule repository 120.

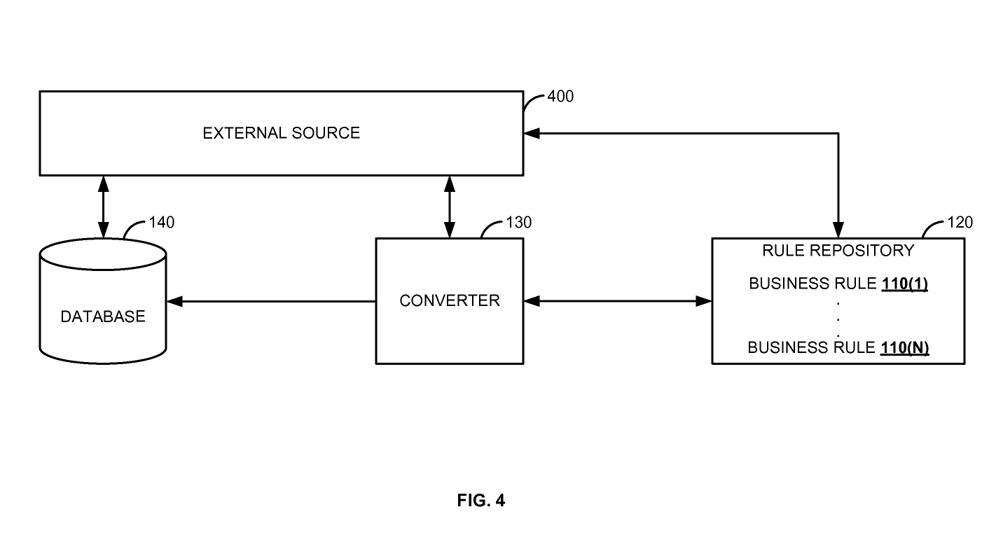

In one embodiment, the converter 130 may receive an update command from an external source 400 (refer to FIG. 4) regarding the new and/or updated business rule(s). The external source 400 may be at least one of a user and a software application. Essentially, when the new business rule(s) are stored in the rule repository 120 or the one or more existing business rules 110 (1-N) are updated (edited) in the rule repository 120, the external source 400 sends an update command to the converter 130. The update command may include name(s) of the new and/or updated business rule(s). In response to the update command, the converter 130 may retrieve the new and/or updated business rule(s) from the rule repository 120. Essentially, the converter 130 is triggered by the external source 400 to retrieve the new and/or updated business rule(s) from the rule repository 120.

Once the business rules 110 (1-N) are retrieved from the rule repository 120, the converter 130 identifies the format of each of the business rules 110 (1-N). For example, the converter 130 may identify the format of the business rule 110(1). Based upon the format of the business rule 110(1), the converter 130 selects a script generator code from a plurality of script generator codes to generate the database script(s) for the business rule 110(1). The plurality of script generator codes may be encoded within the converter 130. In one embodiment, the plurality of script generator codes may be retrieved from one or more external applications that are communicatively coupled to the converter 130. The selected script generator code is executed to generate the database script(s) corresponding to the business rule 110(1).

The generated database script(s) may have one of a plurality of formats namely a first order logical statement (if-then statement), a database table, and an iterative loop statement, etc. The format of the database script(s) depends upon the executed script generator code. Essentially, the converter 130 selects and executes the script generator code based upon the format of the business rule 110(1). For example, if the business rule 110(1) is expressed in the decision table format then the converter 130 may select the script generator code that generates the database script(s) including the database table format. Alternately, for the business rule 110(1) expressed in the decision table format the converter 130 may select the script generator code that generates the database script(s) in a series of logical statements format.

The generated database scripts are sent to the database 140 and/or to the external source 400 for execution. In one embodiment, the converter 130 automatically sends the database scripts to the database 140. In another embodiment, the converter 130 may be triggered by the external source 400 to send the database scripts to the database 140.

The database 140 receives the database scripts from the converter 130. The database scripts are stored in the database 140. The database 140 may receive a query from the external source 400. The query may include data. Based upon the query, the database 140 determines one or more database scripts to be executed on the data. The determined database scripts are executed on the data. As a result of execution, a modified data is generated/obtained. The modified data is stored in the database 140. In one embodiment, the modified data may be communicated to the external source 400. In another embodiment, the modified data may be rendered on a user interface device.

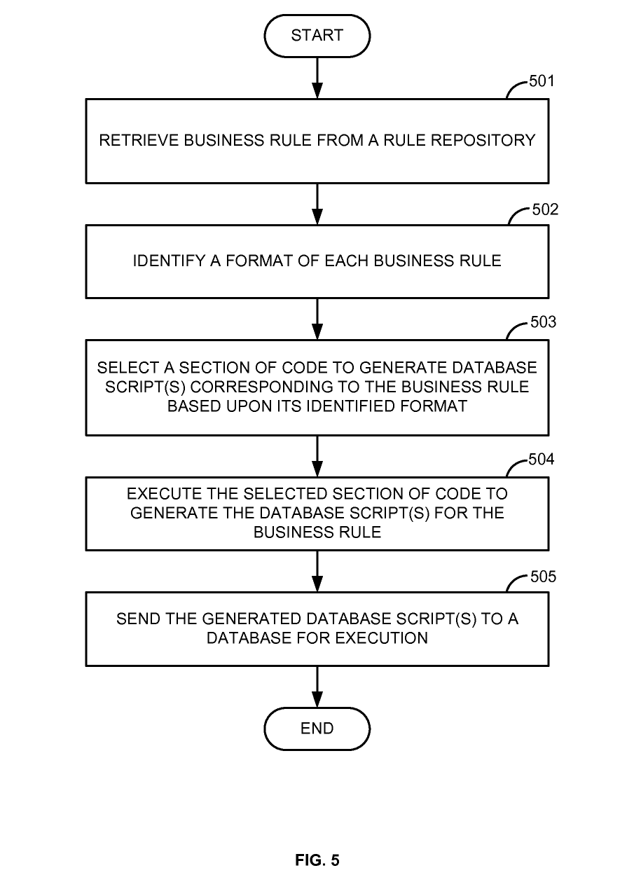

FIG. 5 is a flowchart illustrating a method for generating the database scripts for executing the business rules 110 (1-N) in the database runtime environment. Essentially, the converter 130 retrieves the business rules 110 (1-N) from the rule repository 120 at step 501. Each retrieved business rule is expressed in one of the plurality of formats. The format may be one of the decision table, the decision tree, the conditional statement, the iterative loop statement, the branch condition, and/or any other suitable graphical or non-graphical representation. The converter 130 identifies the format of each of the business rules 110 (1-N) at step 502. Based upon the format of the business rule, the converter 130 selects the script generator code, to be executed, to generate the database script(s) corresponding to the business rule at step 503. The selected script generator code is executed to generate the database script(s) for the business rule at step 504. The database script(s) are sent to the database 140 for execution in the database runtime environment at step 505.

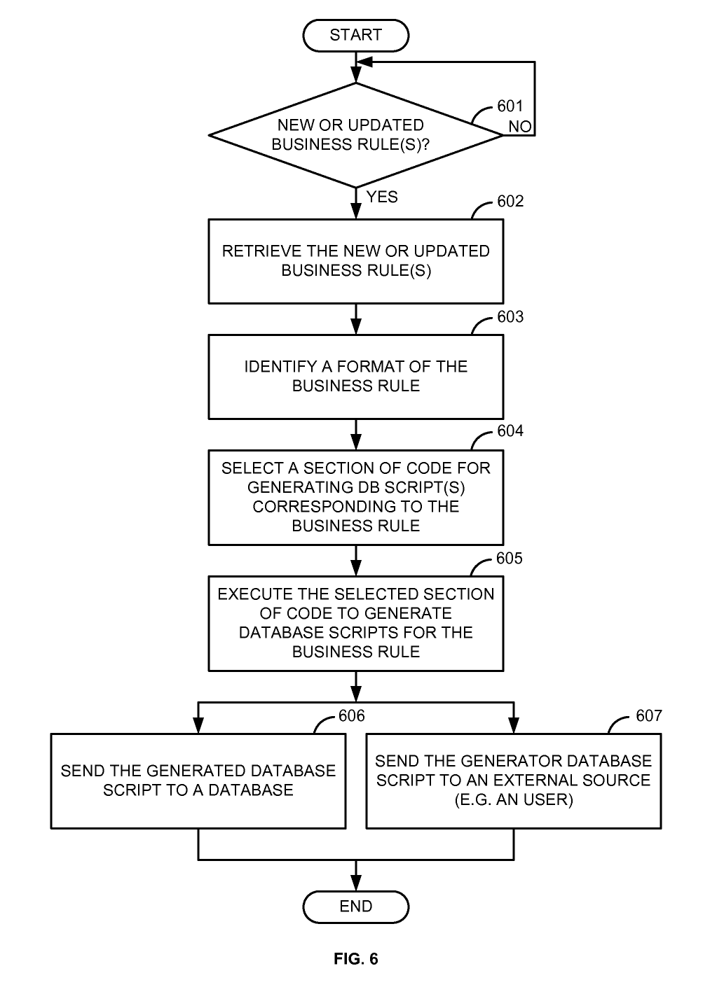

FIG. 6 is a flowchart illustrating a method for generating the database scripts for the new and/or updated business rules 110 (1-N). The rule repository 120 is investigated for the new and/or updated rules 110 (1-N) at step 601. In one embodiment, the converter 130 may investigate or monitor the rule repository 120 for the new and/or updated rules 110 (1-N). The converter 130 may monitor the rule repository 120 at the predefined time interval or continuously. In another embodiment, the rule repository 120 may be investigated by the external source 400. Essentially, the external source 400 sends the update command regarding the new and/or updated business rule(s) to the converter 130. The update command generally includes the name(s) of the new and/or the updated business rule(s). If the new rule(s) are stored in the rule repository 120 or any of the existing business rules 110 (1-N) are updated/edited in the rule repository 120 (step 601: YES), the converter 130 retrieves the new and/or the updated business rules from the rule repository 120 at step 602. In one embodiment, the converter 130 may retrieve the new and/or the updated business rule(s) based upon the update command. Each retrieved business rule is expressed in one of the plurality of formats. The converter 130 identifies the format of the retrieved business rule at step 603. Based upon the format of the business rule, the converter 130 selects the script generator code, to be executed, to generate the database script(s) corresponding to the business rule at step 604. The selected script generator code is executed to generate the database script(s) for the business rule at step 605. The database scripts are sent to the database 140 for execution in the database runtime environment at step 606. In one embodiment, the database scripts may be sent to the external source 400 at step 607.

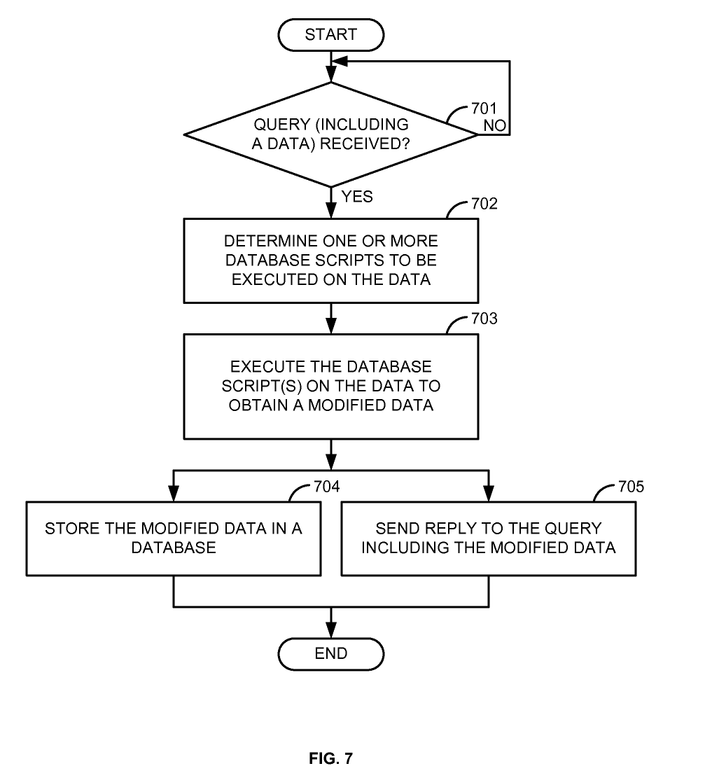

FIG. 7 is a flowchart illustrating a method for executing the business rules 110 (1-N) in the database runtime environment. Essentially, the database 140 investigates if the query (including the data) is received from the external source 400 at step 701. If the query is received (step 701: YES), the database 140 determines the one or more database scripts to be executed on the data at step 702. The determined database scripts are executed on the data to obtain the modified data at step 703. In one embodiment, the modified data is stored in the database 140 at step 704. In another embodiment, the reply including the modified data may be sent to the external source 400 at step 705.

The embodiments of the invention enable an efficient generation as well as efficient execution of the business rules. Specifically, the business rules generated by the BRMS can be executed efficiently in the database runtime environment. Further, database scripts may be generated in various formats based upon the format of the corresponding business rules. Furthermore, the BRMS can be monitored automatically, for the new and/or updated business rules. Additionally, as the converter can automatically converts the new and/or updated business rules in the database scripts, the software developer is not required to be informed each time the rules get updated. Also, the software developer is not required to update the software application each time the business rules get updated. Again, the time consumed in usual IT delivery cycle is also saved.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

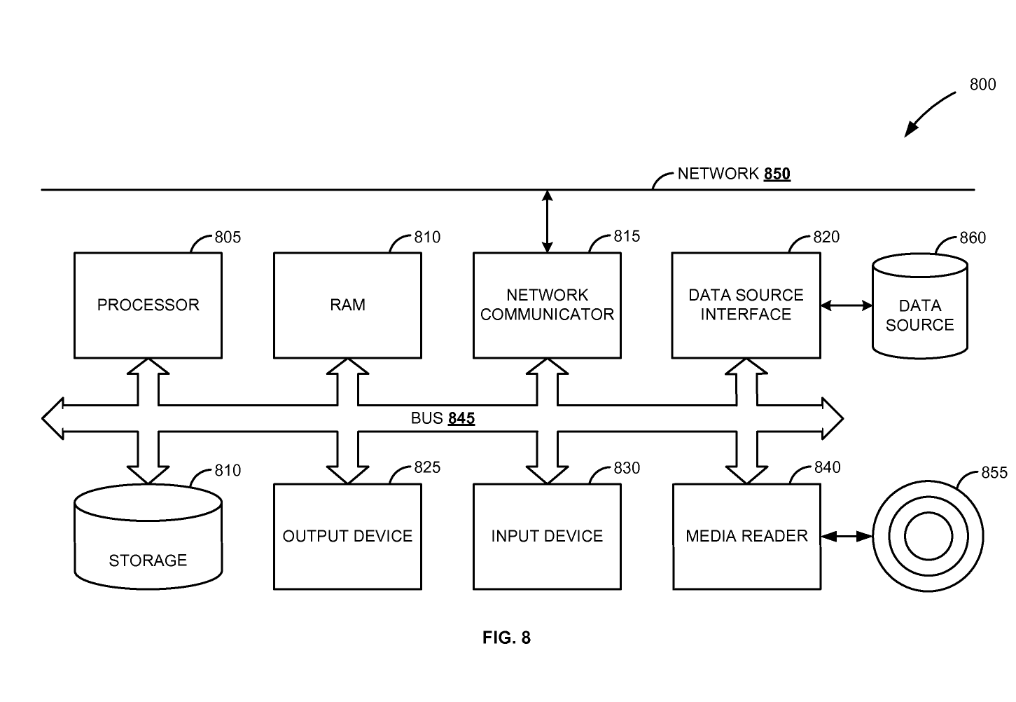

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
retrieve one or more business rules from a rule repository, wherein each business rule is expressed in one of a plurality of formats;
identify the format in which the business rule is expressed;
based upon the identified format, select a script generator code from a plurality of script generator codes to generate one or more database scripts corresponding to the business rule;
execute the selected script generator code to generate the one or more database scripts corresponding to the business rule; and
send the generated one or more database scripts to a database for execution.

2. The article of manufacture of claim 1, wherein the one or more business rules are retrieved in response to a trigger generated by an external source and wherein the external source is at least one of a user and a software application.

3. The article of manufacture of claim 1, wherein the rule repository is at least one of:
a file repository; and
a database repository.

4. The article of manufacture of claim 1, wherein the format comprises one of a decision table, a decision tree, a conditional statement, and a loop statement and wherein the script generator code comprises code for generating one of a first order logical statement, a database table, and an iterative loop statement.

5. The article of manufacture of claim 1 further comprising instructions which when executed cause the computer to:
retrieve the one or more business rules from a business rule management system (BRMS), the BRMS comprising:
a rule manager to enable a business user to maintain the one or more business rules, wherein maintaining the one or more business rules includes at least one of:
generating the one or more business rules; and
updating the one or more business rules; and
a rule composer to enable a software developer to encode the one or more business rules.

6. The article of manufacture of claim 1 further comprising instructions which when executed cause the computer to:
receive an update command related to one or more updated rules;
based upon the command, retrieve one or more updated rules from the rule repository;
generate one or more database scripts corresponding to the updated rule; and
perform at least one of:
sending the generated one or more database scripts to the database; and
sending a reply, including the one or more database scripts, in response to the command.

7. A method for generating database scripts for executing one or more business rules, the method comprising:
retrieving the one or more business rules from a rule repository, wherein each business rule is expressed in one of a plurality of formats;
identifying the format in which the business rule is expressed;
based upon the identified format, selecting a script generator code from a plurality of script generator codes to generate one or more database scripts corresponding to the business rule;
executing the selected script generator code to generate one or more database scripts corresponding to the business rule; and
sending the generated one or more database scripts to a database for execution.

8. The method of claim 7 further comprising:
receiving one or more business rules from a business rule management system; and
storing the received one or more business rules in the rule repository.

9. The method of claim 8 further comprising:
receiving a query including data from an external source;
based upon the received query, determining one or more database scripts to be executed on the data;
executing the one or more database scripts on the data to generate a modified data; and
performing at least one of:
communicating the modified data to the external source; and
storing the modified data into the database.

10. The method of claim 9, wherein the external source is at least one of a user and a software application and wherein communicating the modified data comprises rendering the modified data on a user interface device.

11. The method of claim 7 further comprising:
receiving an update command related to one or more updated rules from an external source;
based upon the command, retrieving the one or more updated rules;
generating one or more database scripts corresponding to the updated rules; and
performing at least one of:
sending the generated one or more database scripts to the database; and
sending a reply including the generated one or more database scripts to the external source.

12. The method of claim 11, wherein the external source is at least one of a user and a software application, and wherein the command includes a name of the business rule being updated.

13. A computer system for generating database scripts for executing one or more business rules, comprising:
a memory to store program code; and
a processor communicatively coupled to the memory, the processor configured to execute the program code to:
retrieve the one or more business rules from a rule repository, wherein each business rule is expressed in one of a plurality of formats;
identify the format in which the business rule is expressed;
based upon the identified format, select a script generator code from a plurality of script generator codes to generate one or more database scripts corresponding to the business rule;
execute the selected script generator code to generate one or more database scripts corresponding to the business rule; and
send the generated one or more database scripts to a database for execution.

14. The system of claim 13, wherein the one or more business rules are retrieved in response to a trigger generated by an external source and wherein the external source is at least one of a user and a software application.

15. The system of claim 13, wherein the format comprises at least one of a decision table, a decision tree, a conditional statement, and a loop statement and wherein the script generator code comprises code for generating one of a first order logical statement, a database table, and an iterative loop statement.

16. The system of claim 13, wherein the database is configured to:
receive and store the one or more database scripts;
receive a query including data from an external source;
based upon the received query, determine the one or more stored database scripts to be executed on the data;
execute the determined one or more database scripts on the data to generate a modified data; and
perform at least one of:
storing the modified data; and
communicating the modified data to the external source.

17. The system of claim 13, wherein the rule repository is at least one of:
a file repository; and
a database repository.

18. The system of claim 13, wherein the retrieved one or more business rules are generated using a business rule management system comprising:
a rule manager to enable a business user to maintain one or more business rules, wherein maintaining one or more business rules includes at least one of generating and updating business rule; and
a rule composer to enable a developer to encode one or more business rules.

19. The system of claim 13, wherein the processor is further configured to:
receive an update command related to one or more updated rules from an external source;
based upon the command, retrieve one or more updated rules from the rule repository;
generate one or more database scripts corresponding to the updated rule; and perform at least one of:
sending the generated one or more database scripts to the database; and
sending a reply including the generated one or more database scripts to the external source.

20. The system of claim 19, wherein the external source is at least one of a user and a software application.
